(19) United States
(12) Patent Application Publication
(10) Pub. No.: US 2005/0114178 A1
(43) Pub. Date: May 26, 2005

(54) Method for processing a workflow for automated patient scheduling in a hospital information system

(76) Inventors: Anand Krishnamurthy, Bangalore (IN); Anish Cleatus, Bangalore (IN)

Correspondence Address: Patrick S. Yoder;FLETCHER YODER, P.O. Box 692289, Houston, TX, 77269-2289, US

(21) Appl. No.: 10/723,186

(22) Filed: Nov. 26, 2003

(51) Int. Cl. G06F 17/60

(52) U.S. Cl. 705/2

(57) ABSTRACT

The present invention provides a workflow for patient scheduling in a Hospital Information System (HIS). While diagnosing a medical problem of a patient, a referring physician may refer a patient for certain exams. The referring physician places a request for ordering the exams with a scheduler that sent to the scheduler in the form of a decision tree. The decision tree includes a first set of exams and additional exams to be performed on a patient. The scheduler orders the exams by scheduling the exams with an acquisition modality and informs the patient about the schedule of the exams. The exams are performed on the patient and medical information from the exams is stored in an archive. The information is also sent to an analyst for analysis. The analyst analyzes the medical images and orders additional exams mentioned in the decision tree based on the results of an exam. The analyst requests additional exams until an end of the decision tree is reached.

### BACKGROUND OF THE INVENTION

The present invention relates to a method for automated patient scheduling for use in Hospital Information Systems (HIS) and similar environments. More specifically, the present invention relates to a workflow for automated scheduling of procedures and resources in such environments.

While addressing medical concerns of a patient, a physician may need certain information about the patient for performing an accurate diagnosis. Such information is typically obtained by performing certain exams on the patient. The exams may generally performed on a site other than the site where the patient is being examined by the physician. Flow of medical information between the different sites involved in a medical procedure is therefore required. The flow of information can be through electronic means or through non-electronic means, such as paper-based methods of communication.

For example, in a hospital, a physician may refer a patient who shows symptoms of neural disorder for an MRI scan of the brain in order to correctly identify the exact nature of the disorder. MRI scans are generally performed on the patient in a radiology department. Therefore, the referring physician needs to send exam-related information to the radiology department of the hospital. This exam-related information includes details about the patient and the exam, along with information regarding a manner in which the exam has to be performed. The exchange of such information can be done through non-electronic means, such as paper-based methods of communication. Alternatively, the exchange of information can be done through electronic means, which may involve a number of healthcare systems, such as an Admit-Discharge-Transfer (ADT) System, a Radiology Information System (RIS) and a Picture Archiving and Communication System (PACS).

The use of a large number of systems in the healthcare information flow leads to the issue of integration of such systems and data. To address this issue, an IHE (Integrating the Healthcare Enterprise) technical framework has been defined for use in the healthcare systems industry. The IHE technical framework is a detailed resource that ensures the integration of different healthcare systems. The IHE technical framework provides a framework based on a set of freely available standards in the healthcare systems industry.

Although the integration of different healthcare systems has increased the speed of information flow, the patient and procedure scheduling process is still not highly efficient. This is due, at least in part, to the limitations arising from the use of conventional workflows. The conventional workflows do not allow for a method of information flow that can minimize undue delays involved in scheduling and analyzing the results of all requisite exams to be performed on the patient. Under the conventional workflows, a patient may be required to visit the referring physician several times (for different exams to be performed on the patient) before an underlying medical issue can be properly diagnosed or addressed. This significantly delays the diagnosis of any medical problem as well as treatment of the patient.

For example, a physician may require an initial exam to be performed on a patient. Based on the results of this exam, the physician may or may not refer the patient for additional exams. Under the conventional workflows, the physician refers the patient for the initial exam by placing a request for the initial exam with a scheduler. The scheduler is an entity that schedules the requested exam and informs the patient about the schedule. The initial exam is performed on the patient as per the schedule and the results of the exam, such as medical images from the initial exam, are reported and may be stored, such as in an image archive. Copies of the reports and supporting documents, such as medical images are sent for analysis to an analyst either electronically or through non-electronic means.

Under conventional workflows, once the initial exam has been performed on the patient, the patient generally leaves the testing facility. The analyst analyzes the medical reports and supporting documents, such as images from the initial exam, and compares the results with the expected results mentioned by the referring physician. The analyst records the analysis of results of the initial exam in a further examination report, which is sent to the referring physician using electronic or non-electronic means.

The referring physician then typically reviews the examination report and requests additional exams to be performed on the patient based on the analysis of results of the initial exam. However, since the patient is not immediately available for these exams, the exams have to be scheduled depending on the patient's next visit to the referring physician. Even if the patient is asked to wait at the testing facility, a significant amount of time may lapse before the referring physician reviews the report and orders additional exams to be performed on the patient. Diagnosis and treatment are thereby delayed until the patient visits the referring physician again or at least until the time the referring physician has ordered additional exams for the patient after reviewing the examination report. This delay in diagnosis and treatment presents a limitation to the use of conventional workflows.

Hence, there exists a need for a workflow and a patient and procedure scheduling method, the use of which can eliminate undue delays involved in the diagnosis and treatment of patients. The workflow and the patient scheduling method based on this workflow should reduce the time that is spent between the referring physician requesting exams to be performed on the patient and his receiving results of the requested exams.

### BRIEF DESCRIPTION OF THE INVENTION

In accordance with one aspect, the present invention provides a method for processing a workflow for automated scheduling of patients in a manner that reduces the time involved in diagnosing a medical condition of a patient. This is achieved by reducing the time spent between the referring physician requesting exams to be performed on the patient and his receiving results of the requested exams.

Under the workflow described in the present invention, the referring physician sends a request to a scheduler for scheduling an initial set of exams to be performed on a patient. The request is sent in the form of a decision tree, which contains a list of exams to be performed on the patient arranged in a hierarchical or tree structure. In the tree structure, each node of the tree comprises an exam along with its details. The details of an exam will typically include exam specifications and expected results of the exam.

Each node of the decision tree can be a “child” of one set of nodes and a “parent” to another set of nodes in the decision tree. Each node of the tree can therefore have no such child nodes downstream, or may have one or more child nodes. Similarly, each child node can have one or more parent nodes. The exams at child nodes comprise additional exams associated with the exam at the parent node.

The scheduler orders the requested exams with an acquisition modality. The acquisition modality is a system that can be used to perform the ordered exams and acquire medical information, such as images, from the ordered exams. The medical information (e.g., images) from the acquisition modality are sent to an image archive where the medical information is stored. The medical images are also sent to an analyst for analysis. The analyst may be any person or entity that analyzes the medical information from the exam. For example, if the medical images are X-Ray or MRI images, the analyst is typically a radiologist. In case of ECG exams where the medical information may include electrocardiographs, and the analyst is typically a cardiologist.

The analyst analyzes the medical information to derive the results of the ordered exams. The analyst may also compare the results of the ordered exams with the expected results for the ordered exams. Based on a comparison of the results of an exam at a parent node with the expected results for the exam, or upon knowledge of the analyst, the analyst may refer the patient for additional exams using the decision tree. The analyst can order additional exams by sending a request directly to the scheduler without being required to consult the referring physician.

The process of ordering additional exams continues until an end of the decision tree is reached. An end of the decision tree is reached when a parent node with no child nodes is reached in the decision tree, or when no further exams are required as determined by the analyst. On reaching an end of the decision tree, the analyst records the results of all exams performed on a patient in an examination report. The examination report is sent to the referring physician, who reviews the analysis provided by the analyst in the examination report and completes the diagnosis of the patient.

### BRIEF DESCRIPTION OF THE DRAWINGS

The various embodiments of the present invention will hereinafter be described in conjunction with the appended drawings provided to illustrate and not to limit the present invention, wherein like designations denote like elements, and in which:

FIG. 1 illustrates a sequence of exemplary steps that are involved in the workflow described in the present invention;

FIG. 2 is a flowchart showing the various exemplary steps involved in the method used for processing the workflow described in the present invention;

FIG. 3 is an illustration of an exemplary decision tree that is provided by a referring physician while placing a request for exams with a scheduler; and

FIG. 4 illustrates a sequence of exemplary steps that are involved in the workflow described in the present invention in accordance with another embodiment of the present invention.

### DETAILED DESCRIPTION OF SPECIFIC EMBODIMENTS

The present technique provides, in part, a method for processing a workflow for patient scheduling in a Hospital Information System (HIS) or other healthcare environment. The workflow described in the present discussion enables automated scheduling of patients and procedures in a manner that reduces the time involved in diagnosing or addressing a medical concerns of a patient. This is achieved by reducing the time spent between the referring physician requesting exams to be performed on the patient and his receiving results of the requested exams.

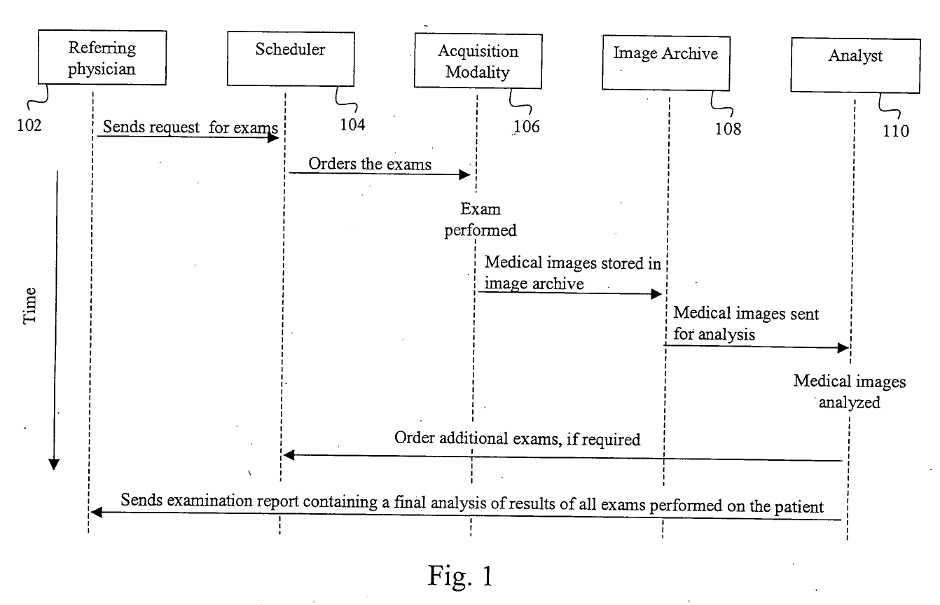

FIG. 1 illustrates the sequence of exemplary steps involved in a workflow process in accordance with aspects of the present technique. The medical healthcare environment in which the present technique may be applied comprises a referring physician 102 who refers a patient for certain exams, such as MRI scans, CT scans, or any other medical procedure or exam designed to aid in diagnosing or addressing the medical concerns of the patient. The medical healthcare environment also includes a scheduler 104, an acquisition modality 106, an information or image archive 108 and an analyst 110.

Scheduler 104 is an entity that orders the requested exams with an acquisition modality 106 by scheduling the exams with acquisition modality 106 and informing patients about the schedule of the scheduled exams Such schedulers may include various hardware, firmware and software components, and will generally include a combination of these, such as programming designed to check for availability of resources, avoid conflicts between the various required resources and schedules of the patient and any practitioners needed for the exams, and so forth. Acquisition modality 106 is a system that can be used to perform the ordered exams on the patient and acquire medical information, such as images, from the ordered exams. For example, in case the referring physician refers a patient for an MRI scan, the acquisition modality would be an MRI system. In this case, the medical information will include the resulting image data and reconstructed images obtained from the MRI scan performed on the patient. In case the referring physician refers a patient for an ECG exam, the acquisition modality will be an ECG system and medical information will include the electrocardiographs obtained from the ECG exam performed on the patient. Again, however, many acquisition modalities may be scheduled in accordance with the present techniques, and these are not limited to imaging modalities.

Moreover, acquisition modality 106 may include a single system or a combination of different systems, which are required in conjunction to perform the ordered exams. Further, the various systems that constitute acquisition modality 106 can be distributed over various locations. For example, acquisition modality 106 may include an MRI system in one department and an X-Ray system in another department of a hospital. In this case, the scheduler schedules the exams at all the constituent systems while ordering the requested exams.

Archive 108 is a repository, and may include various types of storage devices and databases for receiving and storing the medical information, including images from all exams that are performed at acquisition modality 106. Archive 108 can be a central repository, which contains medical information and images from a number of acquisition modalities or can be in the form of a number of different repositories, each containing medical information specific to an acquisition modality. Moreover, any suitable type of repository may be employed for the present purposes, including dedicated memory devices, shared memory devices, magnetic and optical storage technologies, and so forth.

Analyst 110 analyzes the medical images of the exams and sends the results of all exams performed on the patient to referring physician 102. Analyst 110 is generally any person or entity that analyzes the medical information from the exams. Analyst 110 is generally a medical person who has the skill to analyze the medical information collected from the exam. For example, if the medical images collected, such as X-Ray or MRI scan images, the analyst is typically a radiologist. In case of ECG exams, the medical information includes electrocardiographs and the analyst is typically a cardiologist or a physician who has the medical skills to analyze electrocardiographs. Alternatively, analyst 110 can be an automatic image analysis system that analyzes medical images and compares the results of the exam with the expected results mentioned in the decision tree.

In one embodiment, the present technique provides a workflow for patient and procedure scheduling, and a method for processing the workflow, such as in a radiology-related healthcare environment that involves a Radiology Information System (RIS). In such implementations, the healthcare environment in which the embodiment is applied includes one or many image data acquisition modalities 106 located in a radiology department, and analyst 110 is a radiologist. In another embodiment, the present technique provides a workflow for patient and procedure scheduling, and a method for processing the workflow in a cardiology-related healthcare environment. In this implementation, the healthcare environment in which the embodiment is applied includes a cardiology information acquisition modality 106, typically located in a cardiology department, and analyst 110 is typically a cardiologist or a physician.

In the workflow shown in FIG. 1, referring physician 102 places a request with scheduler 104 for ordering certain exams to be performed on a patient. The request is sent by referring physician 102 to scheduler 104 in the form of a decision tree of exams to be performed on the patient. The decision tree sent by referring physician 102 includes details of exams to be performed on a patient. The exams are preferably arranged in a hierarchical or tree structure. In the tree structure, each node of the tree comprises an exam along with its details. The details of an exam may include such instructions and information as exam specifications and expected results of the exam. An exam at a “parent” node is called a parent exam and an exam at its “child” node is referred to as a child exam of the parent exam. As used herein the term “parent” denotes that an exam at a node of the decision tree is logically, and typically temporally, upstream of other exams in the process. Conversely, the term “child” denotes that an exam at a node of the tree is locally, and typically temporally, downstream of other exams.

All the child exams of a parent exam comprise additional exams associated in some way with the parent exam. The additional exams associated with a parent exam can be either supplementary or alternative exams. Alternative exams are performed on a patient when the results of a parent exam do not match the expected results of the parent exam, are inconclusive, or otherwise in need of further development, completion or complement, as determined by the reviewing analyst. In general, supplementary exams are performed on a patient when the results of a parent exam match the expected results. For example, supplementary exams may be required for verifying, probing or refining the results of the parent exam.

Scheduler 104 orders the requested exams by scheduling the requested exams with acquisition modality 106 and informing the patient about the schedule of ordered exams. At acquisition modality 106, the ordered exams are performed and medical information from the ordered exams are obtained. The medical information is then are stored in image archive 108.

The medical information, such as images obtained from the ordered exams, is also sent to analyst 110 for analysis. Analyst 110 analyzes the medical images from each ordered exam to derive the results of the ordered exam. Analyst 110 also compares the results of the ordered exam with the expected results for the exam or makes judgments based upon the analyst's expert knowledge. Based on a comparison of the results of an exam in the decision tree with its expected results, analyst 110 may refer a patient for additional exams associated with the exam. Thus, analyst 110 does not have to consult the referring physician to refer a patient for additional exams. Analyst 110 can refer a patient for additional exams directly by placing a request with scheduler 104. Scheduler 104 orders the additional exams by scheduling the additional exams with acquisition modality 106 and informing the patient about the schedule of the additional exams.

In summary, the medical information from each additional exam performed on the patient is sent to archive 108 for storage and later retrieval. As noted above, the medical information, particularly any images collected during the exams, is also sent to analyst 110 for analysis. Analyst 110 analyzes the medical information and may request further additional exams to be performed on the patient using the decision tree.

Analyst 110 may refer a patient for additional exams repeatedly until an end of the decision tree is reached or until no further exam is warranted. An end of the decision tree is reached when no child exams are mentioned in the decision tree for a parent exam, which was performed on a patient. The process may, of course be stopped by the analyst or physician based upon results from one or more of the exams. On reaching an end of the decision tree, analyst 110 prepares an examination report, which includes the results of all exams performed on the patient. The examination report can also include a final analysis of the results of all exams performed on the patient. The examination report is sent to referring physician 102, who reviews the report and completes the diagnosis of the patient.

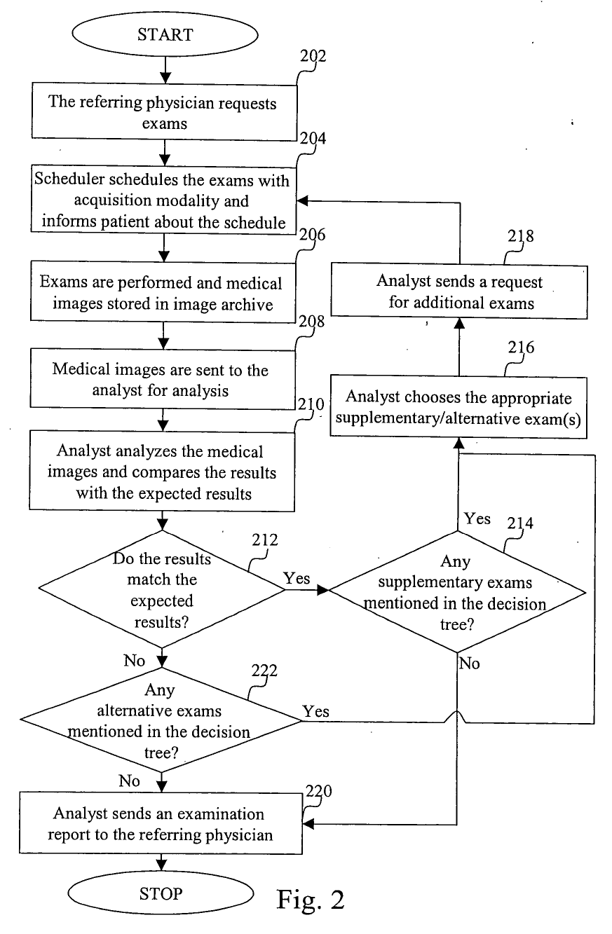

FIG. 2 is a flowchart showing the various exemplary steps involved in the method used for processing the workflow provided in accordance with aspects of the present technique. At step 202, referring physician 102 sends a request to scheduler 104 for ordering exams to be performed on the patient. Referring physician 102 preferably sends the request in the form of a hierarchical list or decision tree, which is to be followed while performing exams on the patient.

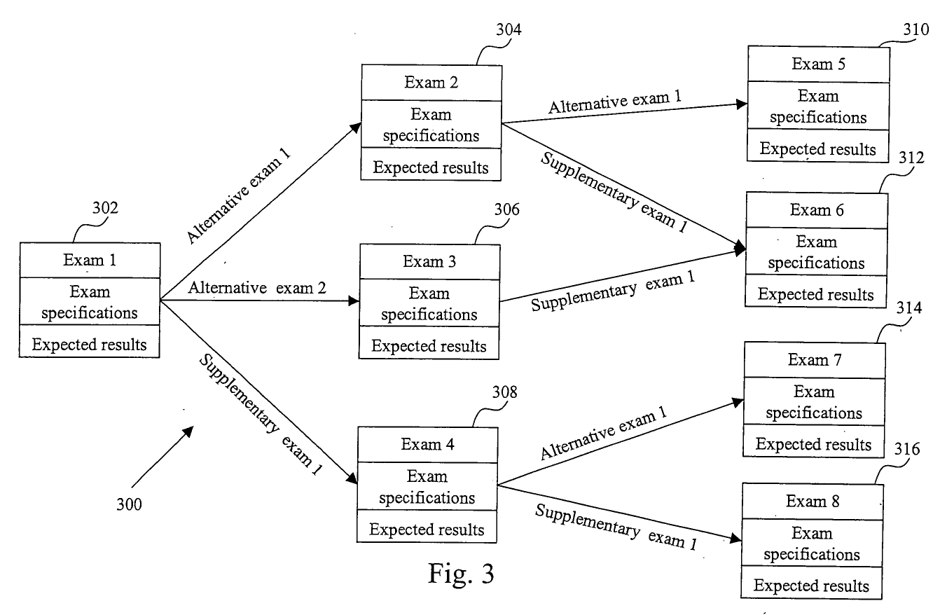

FIG. 3 is an illustration of an exemplary decision tree that is provided by a referring physician while placing a request for exams with a scheduler. In the illustration, decision tree 300 shows eight exams, along with the details of each exam, arranged in a tree structure. Each child exam is a child exam of one or more parent exams. For example, exams 304, 306 and 308 are child exams of parent exam 302. Exam 312 is a child exam of two parent exams 304 and 306. Further, each exam can have one or more child exams, or no child exams at all. For example, exam 302 has three child exams. Exam 304 has two child exams while exams 310, 312, 314 and 316 have no child exams.

The details of each exam are also provided in the decision tree. The details provided for an exam comprise a set of exam specifications and expected results for the exam. The exam specifications specify the manner in which the exam is to be performed at acquisition modality 106, recommendations for the exams, settings, protocols, regions to be examined, and any other relevant details needed or useful in performing the exams in a manner desired by the referring physician. The expected results for an exam are the results expected by referring physician 102 from the exam.

At step 204, scheduler 104 orders the requested exams by scheduling the requested exams with acquisition modality 106 and informing the patient about the schedule of the scheduled exams. Conflicts and availability considerations may also, of course, be taken into account when such information is available. At step 206, the ordered exams are performed at acquisition modality 106 and medical information, including any images acquired from the exams are stored in archive 108. At step 208, the medical information images from the exams is sent to analyst 110 for analysis. At step 210, analyst 110 analyzes the medical images of the ordered exams to derive results of the ordered exams. At step 212, analyst 110 checks whether the results of an ordered exam performed on the patient match the expected results for the ordered exam.

A match of results of an exam with the expected results for the exam implies that the results of the exam are substantially the same as the results expected by the referring physician. However, even when the results of an exam match the expected results, the referring physician may require certain additional exams to be performed on the patient. For example, these additional exams may be required to verify or probe the results of the exam. In such a case, the referring physician will mention supplementary exams among the child exams of the exam performed on the patient.

Referring back to step 212, in case the results of an exam match the expected results, step 214 is performed. At step 214, analyst 110 checks to determine whether the exam has any supplementary exams among its child exams in the decision tree. There can be a multiplicity of supplementary exams among the child exams of a parent exam in the decision tree. If one or more supplementary exams exist among the child exams, step 216 is performed. At step 216, analyst 110 chooses the appropriate supplementary exam(s) from among the multiplicity of supplementary exams. The choice of the appropriate supplementary exam(s) from among the multiplicity of supplementary exams is based on the results of the parent exam. Thereafter, at step 218, analyst 110 sends a request to scheduler 104 for ordering the chosen supplementary exams(s).

Referring back to step 214, in case no supplementary exams are mentioned among the child exams of the parent exam in the decision tree, then step 220 is performed. For example, in decision tree 300 of FIG. 3, exams 310, 312, 314 and 316 have no supplementary exams as their child exams in the decision tree. Hence, whenever a patient is referred for one of these exams, step 220 is performed. At step 220, analyst 110 prepares an examination report, which contains results of all exams performed on the patient. The examination report can also include a final analysis of the results of all exams performed on the patient. The examination report is sent to referring physician 102, who reviews the examination report and completes the diagnosis or treatment of the patient.

Referring back to step 212, in case the results of an exam performed on the patient do not match the expected results, then step 222 is performed. At step 222, analyst 110 checks to determine whether the exam has any alternative exams among its child exams in the decision tree. In case alternative exams are mentioned in the decision tree, step 216 is performed. At step 216, analyst 110 chooses the appropriate alternative exam(s) from among the alternative exams mentioned in the decision tree. The choice of appropriate alternative exam(s) from among the alternative exams mentioned in the decision tree is based on the results of the parent exam in the decision tree that was performed on the patient. Thereafter, at step 218, analyst 110 sends a request to scheduler 104 for ordering the chosen alternative exam(s).

For example, in FIG. 3, exam 302 in decision tree 300 has two alternative exams 304 and 306 and one supplementary exam 308 among its child exams. Based on a comparison of results of parent exam 302 with the expected results for parent exam 302, analyst 110 may refer a patient for alternative exams 304 or 306, or supplementary exam 308. If the results of parent exam 302 match with the expected results for parent exam 302, then analyst 110 refers the patient for supplementary exam 308. However, if the results of parent exam 302 do not match the expected results for parent exam 302, then analyst 110 refers the patient for alternative exams 304 or 306. Based on the results of exam 302, analyst 110 chooses one or both of alternative exams 304 and 306 and refers the patient for the chosen alternative exam(s).

Referring back to step 222, in case no alternative exams exist among the child exams of the parent exam in the decision tree, then step 220 is performed. For example, in decision tree 300 of FIG. 3, exams 310, 312, 314 and 316 have no alternative exams among their child exams. Hence, whenever a patient is referred for one of these exams, analyst 110 need not refer a patient for any alternative exams, and step 220 is performed.

The present invention provides the advantage of reducing the time involved in the diagnosis and treatment of a patient. The workflow described in the present invention allows a referring physician to refer a patient for additional exams using a decision tree provided by the referring physician. The analyst is not required to consult the referring physician before referring a patient for additional exams. Hence, the time spent between the referring physician requesting exams and his obtaining the results of the exams is reduced.

The present invention also provides the advantage of reducing the waiting time and the number of visits that a patient has to make to a referring physician during the course of a diagnosis and treatment. The analyst can order additional exams directly based on the analysis of results of an exam performed on the patient. The analyst does not have to consult the referring physician before ordering the exam. Hence, the waiting time of the patient and the number of visits, which would otherwise be required under conventional workflows, are reduced.

Further, the workflow described herein also provides the advantage of reducing exposure, in certain contexts, to exam environments. For example, for X-ray procedures the radiation total dose to which a patient is exposed during the course of the diagnosis may be reduced. This results from the use of the workflow described herein, that ensures that only the necessary exams are performed on a patient. The exams to be performed on a patient are chosen objectively using the decision tree and hence the possibility of subjecting the patient to unnecessary exams is minimized.

The method for processing the workflow described in the present invention can be implemented in a HIS through the use of transactions based on standards such as DICOM, HL7 and other communication standards that for part of the IHE technical framework. For implementing the method for processing the workflow in a HIS, each entity constituting the workflow is assigned a role. The role assigned to an entity defines a set of transactions for which the entity is responsible. For example, a transaction for sending the medical images from an exam to an image archive is a part of the role assigned to an acquisition modality. A transaction for sending an examination report to a referring physician is a part of the role assigned to an analyst. By defining such roles for each entity that forms part of the workflow, the method for processing the workflow is implemented.

However, the present invention is not limited to the embodiments described above. The workflow, as described herein can be implemented in all healthcare environments which require exams to be performed on a patient in the course of diagnosis or treatment of patients. In all such healthcare environments, the use of a decision tree for communicating a series of exams to be performed on the patient can reduce the undue delays involved in scheduling and analyzing the results of exams to be performed in a medical procedure.

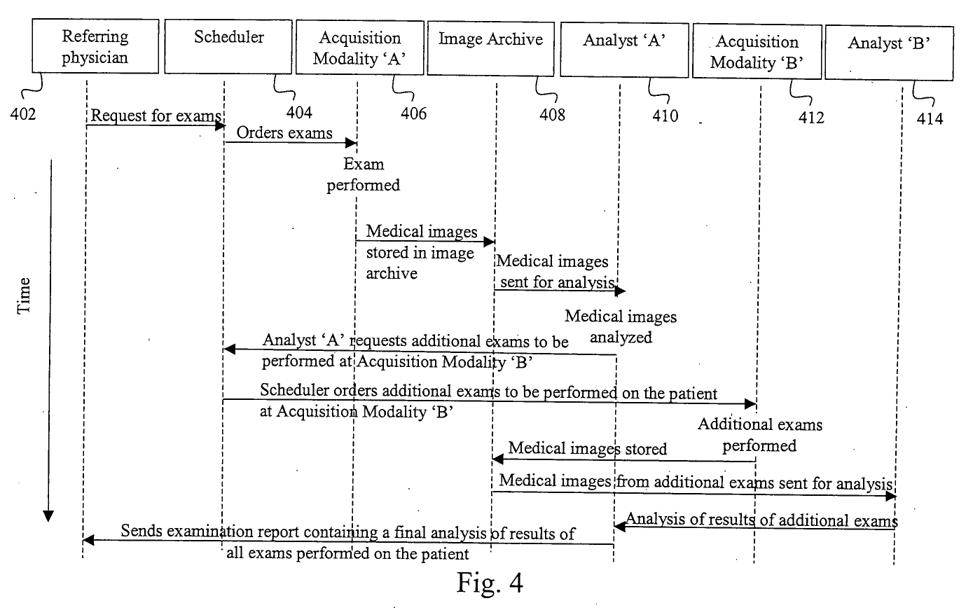

It will be apparent to a person skilled in the art that the workflow can also be implemented in healthcare environments which include multiple acquisition modalities and multiple analysts in the healthcare environment. An illustration of such a healthcare environment is provided in FIG. 4. FIG. 4 illustrates a sequence of exemplary steps that are involved in the workflow described in the present invention in accordance with another embodiment of the present invention. In the healthcare environment shown in FIG. 4, there are two acquisition modalities and two analysts, although many more such modalities and analysts may, of course, participate in a diagnosis or treatment program. Referring physician 402 refers a patient for certain exams by placing a request with scheduler 404 for ordering the exams to be performed on a patient. The request is sent by referring physician 402 to scheduler 404 in the form of a decision tree of exams to be performed on the patient.

The decision tree sent by referring physician 402 includes details of exams to be performed on a patient. The exams are arranged in a hierarchical listing or tree structure as described above. In the tree structure, each node of the tree comprises an exam along with its details. The details of an exam include exam specifications and expected results of the exam. An exam at a parent node is again called a parent exam and an exam at its child node is referred to as a child exam of the parent exam.

Scheduler 404 orders the requested exams by scheduling the requested exams with acquisition modality ‘A’ 406, where the required exams can be performed. Scheduler 404 also informs the patient about the schedule of ordered exams. At acquisition modality ‘A’ 406, the ordered exams are performed and medical information, possibly including images from the ordered exams, is obtained. The medical information is stored in archive 408. The medical information obtained from the exams performed at acquisition modality ‘A’ 406 are sent to analyst ‘A’ 410 for analysis. Analyst ‘A’ 410 analyzes the medical information from each exam performed at acquisition modality ‘A’ 406 to derive the results of the exam. Analyst ‘A’ 410 also compares the results of the ordered exam with the expected results for the exam. Based on a comparison of the results of an exam in the decision tree with its expected results, analyst ‘A’ 410 may refer a patient for additional exams associated with the exam. The additional exams need to be performed at another acquisition modality ‘B’ 412.

For example, a referring physician may refer a patient for certain exams, such as an EEG (Electro-encephalogram) to be performed on the patient in the neurology department by providing a decision tree for a neurologist. Based on the results of the exams that are performed on the patient, the neurologist may refer the patient for additional exams, such as an MRI scan in the radiology department by providing a decision tree for a radiologist. In this case, acquisition modality ‘A’ 406 is an EEG system in the neurology department, and acquisition modality ‘B’ 412 is an MRI system in the radiology department.

As before, analyst ‘A’ 410 does not have to consult the referring physician to refer a patient for additional exams. Analyst ‘A’ 410 can refer a patient for additional exams to be performed at acquisition modality ‘B’ 412 directly by placing a request with scheduler 104. While placing the request for additional exams, Analyst ‘A’ 410 provides a decision tree containing details about the exams to be performed on the patient at acquisition modality ‘B’ 412 along with the results of these exams. Scheduler 404 orders the additional exams by scheduling the additional exams with acquisition modality ‘B’ 412 and informing the patient about the schedule of the additional exams.

The medical information, such as images and image data of each additional exam performed on the patient at acquisition modality ‘B’ 412 are stored in archive 408. The medical information is also sent to analyst ‘B’ 414 for analysis. Analyst ‘B’ 414 analyzes the medical information and can order further additional exams to be performed on the patient using the decision tree provided by analyst ‘A’ 410. Analyst ‘B’ 414 can order the further additional exams by placing a request for the exams directly with scheduler 404 without being required to consult either analyst ‘A’ 410 or referring physician 402.

Analyst ‘B’ 414 may refer a patient for further additional exams until an end of the decision tree provided by analyst ‘A’410 is reached. An end of the decision tree is reached when no child exams are mentioned in the decision tree for a parent exam, which was performed on a patient. On reaching an end of the decision tree, analyst ‘B’ 414 sends an analysis of results of all exams performed on the patient at acquisition modality ‘B’ 412 to analyst ‘A’ 410.

On receiving the analysis of results from analyst ‘B’ 414 and analyzing the same, analyst ‘A’ 410 can order additional exams mentioned in the decision tree provided by the referring physician 402 until an end of the decision tree is reached. On reaching an end of the decision tree provided by referring physician 402, analyst ‘A’ 410 prepares an examination report, which includes the results of all exams performed on the patient. The examination report can also include a final analysis of the results of all exams performed on the patient. The examination report is sent to referring physician 402, who reviews the report and completes the diagnosis of the patient.

It will be apparent to a person skilled in the art that the above-mentioned embodiment of the present invention is not limited to implementation in healthcare environments that include two acquisition modalities and two analysts. The workflow described in the present invention can be implemented in healthcare environments, which include any number of acquisition modalities and corresponding of analysts for analyzing the medical information obtained from the exams performed at the acquisition modalities.

While the various embodiments of the present invention have been illustrated and described, it will be clear that the present invention is not limited to these embodiments only. Numerous modifications, changes, variations, substitutions and equivalents will be apparent to those skilled in the art without departing from the spirit and scope of the present invention as described in the claims.

1. A method for processing a workflow for patient scheduling in a Hospital Information System, the method comprising:
sending a request for ordering exams to be performed on a patient to a scheduler, the request being sent by a referring physician in the form of a decision tree of exams to be performed on the patient;
ordering the requested exams, the order being placed by the scheduler with an acquisition modality, the acquisition modality being a system that can perform the ordered exams;
performing the ordered exams on the patient at the acquisition modality;
requesting additional exams to be performed on the patient based on an analysis of results of the ordered exams, the analysis being done by an analyst and the additional exams being requested by the analyst until an end of the decision tree is reached; and
sending results of all exams performed on the patient to the referring physician, the results being sent to the referring physician by the analyst.

2. The method of claim 1, wherein the decision tree provided by the referring physician comprises:
additional exams to be performed on the patient based on results of exams performed on the patient;
exam specifications for all exams mentioned in the decision tree, the exam specifications for an exam specifying a manner in which the exam is to be performed; and
expected results for all exams mentioned in the decision tree.

3. The method of claim 2, wherein each exam in the decision tree can be a parent exam of zero or more child exams and can also be a child exam of one or more parent exams.

4. The method of step 1, wherein ordering the requested exams comprises:
scheduling the requested exams with the acquisition modality; and
informing the patient about the schedule of the scheduled exams.

5. The method of claim 1, wherein performing the ordered exams comprises:
performing the ordered exams on the patient in accordance with the exam specifications to obtain medical images of the ordered exams;
storing the medical images of the ordered exams in an image archive; and
sending the medical images of the ordered exams to the analyst for analysis.

6. The method of claim 5, wherein the image archive is a database of medical images of all exams performed on patients at the acquisition modality.

7. The method of claim 1, wherein requesting additional exams to be performed on the patient comprises:
analyzing the medical images to derive results of the ordered exams, the analysis of medical images being done by the analyst;
comparing the results of the ordered exams with the expected results of the ordered exams, the comparison of the results being performed by the analyst; and
requesting additional exams, as mentioned in the decision tree, to be performed on the patient based on the results of a parent exam, the request for the additional exams being sent by the analyst directly to the scheduler.

8. The method of claim 7, wherein additional exams comprise:
alternative exams to be performed on the patient in case the results of a parent exam performed on the patient do not match the expected results for the parent exam; and
supplementary exams to be performed on the patient in case the results of a parent exam match the expected results for the parent exam.

9. The method of claim 1, wherein an end of the decision tree is reached when a parent exam is reached that does not have any child exams which can be ordered by the analyst based on results of the parent exam, in the decision tree.

10. The method of claim 1, wherein the results of all exams are sent by the analyst to the referring physician, who reviews the results and completes the diagnosis of the patient.

11. A method for processing a workflow for patient scheduling in a Hospital Information System, the method comprising:
sending a request for ordering exams to be performed on a patient to a scheduler, the request being sent by a referring physician in the form of a decision tree of exams to be performed on the patient, wherein the decision tree comprises:
additional exams to be performed on the patient based on results of exams which were performed on the patient;
exam specifications for all exams mentioned in the decision tree, the exam specifications for an exam specifying a manner in which the exam is to be performed; and
expected results for all exams mentioned in the decision tree;
ordering the requested exams, the order being placed by the scheduler with an acquisition modality, the acquisition modality being a system that can perform the ordered exams;
performing the ordered exams on the patient at the acquisition modality wherein performing the ordered exams comprises:
performing the ordered exams on the patient in accordance with the exam specifications to obtain medical images of the ordered exams;
storing the medical images of the ordered exams in an image archive; and
sending the medical images of the ordered exams to an analyst for analysis;
requesting additional exams to be performed on the patient based on an analysis of results of the ordered exams, the analysis being done by the analyst and the additional exams being requested by the analyst till an end of the decision tree is reached wherein requesting additional exams comprises:
analyzing the medical images to derive results of the ordered exams, the analysis of medical images being done by the analyst;
comparing the results of the ordered exams with the expected results of the ordered exams, the comparison of the results being performed by the analyst; and
requesting additional exams, as mentioned in the decision tree, to be performed on the patient based on the results of the ordered exams, the request for the additional exams being sent by the analyst directly to the scheduler; and
preparing an examination report and sending it to the referring physician, the examination report containing a final analysis of the results of all exams performed on the patient.

12. The method of claim 11 wherein each exam in the decision tree can be a parent exam of zero or more child exams and can also be a child exam of one or more parent exams.

13. The method of claim 11 wherein an end of the decision tree is reached when a parent exam is reached that does not have any child exams, which can be ordered by the analyst based on results of the parent exam, in the decision tree.

14. A method for processing a workflow for patient scheduling in a Hospital Information System, the method comprising the steps of:
sending a request for ordering exams to be performed on a patient to a scheduler, the request being sent by a referring physician in the form of a decision tree of exams to be performed on the patient wherein the decision tree comprises:
additional exams to be performed on the patient based on results of exams, which were performed on the patient;
exam specifications for all exams mentioned in the decision tree, the exam specifications for an exam specifying a manner in which the exam is to be performed; and
expected results for all exams mentioned in the decision tree; and
ordering the requested exams, the order being placed by the scheduler with an acquisition modality, the acquisition modality being a system that can perform the ordered exams, wherein ordering the requested exams comprises:
scheduling the requested exams with the acquisition modality; and
informing the patient about the schedule of the scheduled exams;
performing the ordered exams on the patient at the acquisition modality wherein performing the ordered exams comprises:
performing the ordered exams on the patient in accordance with the exam specifications to obtain medical images of the ordered exams;
storing the medical images of the ordered exams in an image archive; and
sending the medical images of the ordered exams from the image archive to an analyst for analysis;
requesting additional exams to be performed on the patient based on an analysis of results of the ordered exams, the analysis being done by the analyst wherein requesting additional exams comprises:
analyzing the medical images to derive results of the ordered exams, the analysis of medical images being done by the analyst;
comparing the results of the ordered exams with the expected results of the ordered exams, the comparison of the results being performed by the analyst; and
requesting additional exams, as mentioned in the decision tree, to be performed on the patient based on the results of the ordered exams, the request for the additional exams being sent by the analyst directly to the scheduler and the additional exams being requested by the analyst till an end of the decision tree is reached wherein the additional exams comprise:
alternative exams to be performed on the patient in case the results of an exam performed on the patient do not match the expected results for the exam; and
supplementary exams to be performed on the patient in case the results of an exam match the expected results; and
preparing an examination report and sending it to the referring physician, the examination report containing a final analysis of the results of all exams performed on the patient.

15. The method of claim 14 wherein each exam in the decision tree can be a parent exam of zero or more child exams and can also be a child exam of one or more parent exams.

16. The method of claim 14 wherein an end of the decision tree is reached when a parent exam is reached that does not have any child exams, which can be ordered by the analyst based on results of the parent exam, in the decision tree.

17. A method for scheduling patient exams comprising:
generating a hierarchical listing of exams to be performed in desired sequences, including exams desired before and after other exams based upon results of the exams;
scheduling resources and patients for exams in accordance with the listing, the scheduling continuing without final reporting until all exams in a family of exams have been performed in accordance with the listing; and
reporting results of the exams upon completion of a final exam in a family of exams.

18. The method of claim 17, wherein the hierarchical listing comprises a decision tree having a plurality of nodes corresponding to exams.

19. The method of claim 17, wherein the hierarchical listing includes recommendations for how exams are to be performed.

20. The method of claim 17, wherein each exam may follow one or more exams in a family.

21. The method of claim 17, wherein each exam may be followed by one or more exams in a family.

22. The method of claim 17, wherein the resources include at least two different examination modalities.

23. The method of claim 22, wherein at least one of the modalities is an imaging modality.

24. A system for scheduling patient exams comprising:
means for generating a hierarchical listing of exams to be performed in desired sequences, including exams desired before and after other exams based upon results of the exams;
means for scheduling resources and patients for exams in accordance with the listing, the scheduling continuing without final reporting until all exams in a family of exams have been performed in accordance with the listing; and
means for reporting results of the exams upon completion of a final exam in a family of exams.

25. A computer program for scheduling patient exams comprising:
at least one computer readable medium; and
computer readable code on the at least one computer readable medium including routined for generating a hierarchical listing of exams to be performed in desired sequences, including exams desired before and after other exams based upon results of the exams, scheduling resources and patients for exams in accordance with the listing, the scheduling continuing without final reporting until all exams in a family of exams have been performed in accordance with the listing, and reporting results of the exams upon completion of a final exam in a family of exams.
